(19) United States
(12) Patent Application Publication
(10) Pub. No.: US 2008/0126346 A1
(43) Pub. Date: May 29, 2008

(54) Electronic Data Transaction Processing Test and Validation System

(75) Inventor: Hui Zheng, Downingtown, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/940,579

(22) Filed: Nov. 15, 2007

Related U.S. Application Data
(60) Provisional application No. 60/867,607, filed on Nov. 29, 2006.

(51) Int. Cl. G06F 17/30

(52) U.S. Cl. 707/6; 707/E17.039

(57) ABSTRACT

An electronic transaction message test data generator provides large amounts of standard (e.g., EDI 835) healthcare reimbursement claim test data comprising payment advice data that would be provided by a payer organization using logic and business rules to verify the format of the data. A system provides electronic transaction data for use in testing an executable application. The system includes a source of a predetermined template transaction file comprising data representing a transaction and including at least one placeholder tag representing a transaction data element for replacement by a corresponding transaction data element derived from stored non-test transaction data. An acquisition processor acquires non-test transaction data of a predetermined type from a transaction data repository. A data generator matches and replaces a placeholder tag in predetermined template transaction file data with a corresponding transaction data element in the acquired transaction data of the predetermined type to provide output transaction data.

This is a non-provisional application of provisional application Ser. No. 60/867,607 filed Nov. 29, 2006, by H. Zheng.

### FIELD OF THE INVENTION

This invention concerns a system for providing electronic transaction data for use in testing an executable application using non-test transaction data.

### BACKGROUND OF THE INVENTION

The creation of transaction test data for testing executable applications in a healthcare financial data processing system, for example, is a time consuming task that is typically done with extensive manual involvement by senior analysts having specific transaction processing knowledge. An EDI (Electronic Data Interchange) 835 transaction compatible with Accredited Standards Committee (ASC) X12 format, is used to make a payment, send an Explanation of Benefits (EOB) remittance advice or make a payment for reimbursement for healthcare services provided to patients, for example. An EDI 835 transaction is used to send an EOB remittance advice from a healthcare insurer to a healthcare provider, either directly or through a financial institution. Further, test data created for one environment typically cannot be reused for another environment.

The information in EDI 835 test data messages needs to match data that exists in an application database, such as payer tax identifier, claim information, claim line revenue code, procedure code and procedure modifier. Multiple EDI 835 files need to be created for a development, testing and deployment environment. This may be facilitated by copying data from one EDI 835 message file to another but this is an error prone task and the resulting EDI 835 file may have inconsistent information. In known systems, validation of EDI 835 file processing at a user site is minimal since most client support staff do not have the time and expertise required to create EDI 835 test data. Known systems are also manually intensive involving manual creation of database queries to retrieve certain claims from a database having particular characteristics such as type of claim and payment option. The created queries are used to retrieve claim data from a database for use in manual creation of EDI 835 message remittance files.

Known systems involve a substantial risk of creating invalid data for testing of EDI 835 data processing due to the manual nature of creating files involving finding valid test data from within a database. Further, extensive knowledge is required to understand what information is required in EDI 835 files and what logical relationship there is between transaction data elements to generate valid test files. A system according to invention principles addresses these deficiencies and related problems.

### SUMMARY OF THE INVENTION

An electronic transaction message test data generator provides large amounts of standard (e.g., EDI 835) healthcare reimbursement claim test data using real transaction message data in a healthcare financial information system database and using logic and business rules to verify the format of the data. A system provides electronic transaction data for use in testing an executable application. The system includes a source of a predetermined template transaction file comprising data representing a transaction and including at least one placeholder tag representing a transaction data element for replacement by a corresponding transaction data element derived from stored non-test transaction data. An acquisition processor acquires non-test transaction data of a predetermined type from a transaction data repository. A data generator matches and replaces a placeholder tag in predetermined template transaction file data with a corresponding transaction data element in the acquired transaction data of the predetermined type to provide output transaction data.

### BRIEF DESCRIPTION OF THE DRAWING

FIG. 1 shows a system and process for providing electronic transaction data for use in testing an executable application, according to invention principles.

FIG. 2 shows a user interface dialog box enabling a user to select a source of data for use providing transaction message test data, according to invention principles.

FIG. 3 shows a user interface display image employed by a system for providing electronic transaction data for use in testing an executable application, according to invention principles.

FIG. 4 shows a user interface display image window for navigating to select a template transaction message test data file, according to invention principles.

FIG. 5 shows the user interface display image employed by the system for providing electronic transaction data illustrating selection of financial claims to be included in a test file, according to invention principles.

FIG. 6 shows the user interface display image employed by the system for providing electronic transaction data illustrating selection of lines of financial claims to be included in a test file, according to invention principles.

FIG. 7 shows an EDI 835 test data template file, according to invention principles.

FIG. 8 shows a generated EDI 835 test data file, according to invention principles.

FIG. 9 shows a system for performing a process for providing electronic transaction data for use in testing an executable application, according to invention principles.

### DETAILED DESCRIPTION OF THE INVENTION

An electronic transaction message test data generator provides relatively large amounts of standard (e.g., EDI 835) healthcare reimbursement claim test data using real transaction message data in a healthcare financial information system database. The transaction message test data generator allows relatively large amounts of standard claim payment and advice (835) test data to be generated representing payer organization provided data. The transaction message test data generator does this by accessing claim information directly from a healthcare financial information system database and employs a user interface to facilitate customizing EDI 835 test data for various test scenarios. The system improves the quality of EDI 835 test data generated by using real data acquired from a healthcare system database and using existing business rules to verify the format of the data. The customization is achieved by user selection from a list of pre-defined test template data files, for example and claim data is extracted from the database and combined with selected template data. A set of test template data files is provided to a user site and combined with extracted data from a user database to generate 835 test data.

The system also enables Test Driven Development (TDD) for remittance processing as a reusable test fixture for electronic remittance processing and provides an EDI 835 test file associated with a specific database and with a specific claim and claim line information at the time of testing. The system also supports regression testing of an electronic remittance processing system and provides higher quality tests and better test coverage of programs by being integrated with a healthcare financial information system. The system automatically extracts data from an existing database and removes the need to manually search a healthcare financial information system database for valid claim data to be used in an EDI 835 test data remittance file. The system uses existing programmed business logic to generate EDI 835 files and ensures synchronization with healthcare financial information system business rules which reduces data integrity problems. The system further, ensures correct formatting of EDI 835 files using tested template data files. Further, costs are reduced since an analyst is no longer required to edit test data to generate valid test cases and a list of pre-defined test data templates can be provided to be combined with data extracted from customer database to generate test files.

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of a controller or microprocessor, for example. The processor may operate with a display processor or generator. A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

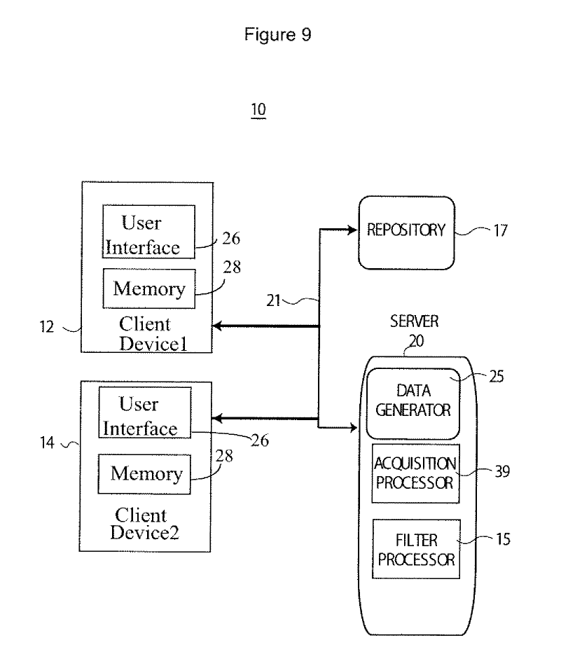

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps (e.g., of FIG. 9) herein may be performed automatically or wholly or partially in response to user command. An activity (including a step) performed automatically is performed in response to executable instruction or device operation without user direct initiation of the activity. A document or record comprises a compilation of data in electronic form and is the equivalent of a paper document and may comprise a single, self-contained unit of information.

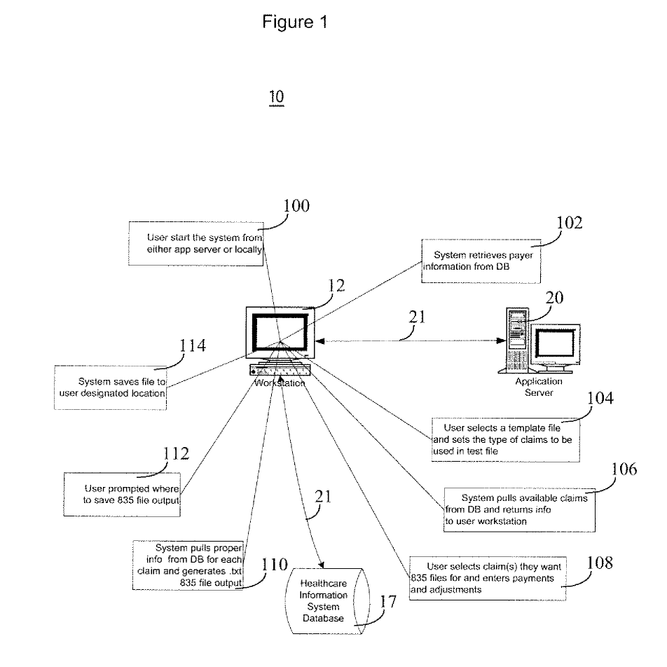

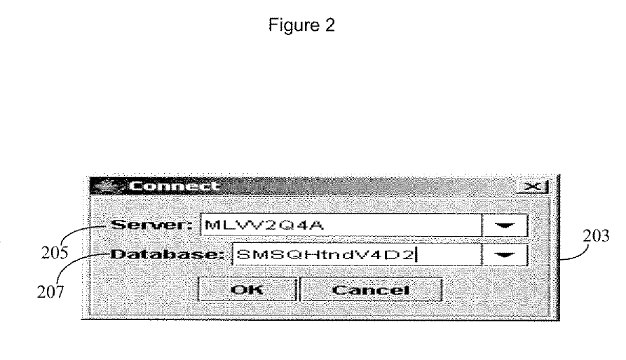

FIG. 1 shows a system 10 for providing electronic transaction data, specifically an EDI 835 test data file, for use in testing an executable application. A user initiates system operation from either application server 20 or local workstation 12 in step 100. Information is retrieved from a healthcare financial information system database (repository 17) that includes a list of payer organizations and types of claims that are present in the database in step 102. A user selects a source of data for use in providing transaction message test data via a user interface dialog box 203 as illustrated in FIG. 2, presented on workstation 12 in response to user initiation of system operation. Specifically, a user selects a server 205 (e.g., server 20 of FIG. 1) and a database 207 via box 203 from which to extract data for an EDI 835 test data file. A user selects a pre-defined template file to be used as a base for a generated EDI 835 test data file and sets the type of claims to be included in the test file in step 104.

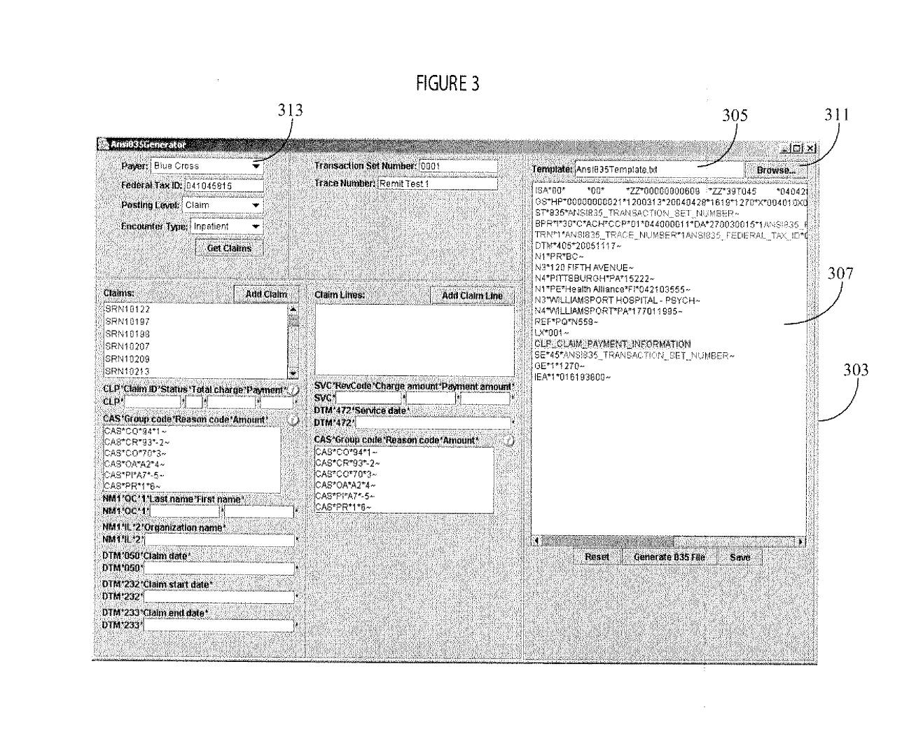

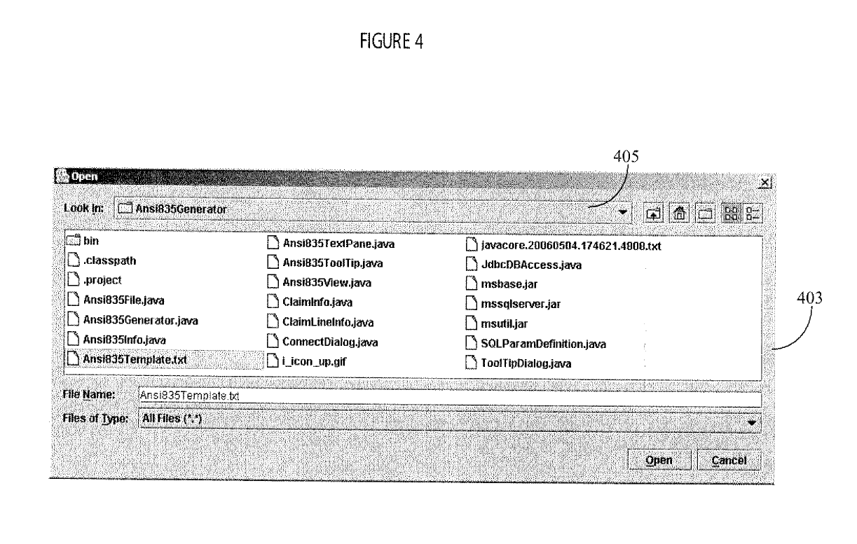

Specifically, a user selects a pre-defined template file to be used as a base for a generated EDI 835 test data file via user interface display image 303 as illustrated in FIG. 3. A user selected pre-defined template file is retrieved from workstation 12 or application server 20 and displayed in display image 303 and comprises payer organization provided data indicating the result of adjudication of a submitted claim under an insurance reimbursement policy, for example. An EDI 835 data file is provided by a specific payer organization and a user selects a particular payer organization from a list of payers using option list 313. Option list 313 includes payer organizations that employ electronic remittance processing and for which previously adjudicated claim data is available in repository 17. A user selects a pre-defined template file to be used as a base to construct an EDI 835 test file in box 305. The content of the selected template file is presented in image window area 307. FIG. 4 shows user interface display image window 403 for navigating to select a template transaction message test data file 405 from a local or (remote) network drive displayed in response to user selection of browse button 311 (FIG. 3). A default template EDI 835 test data file is employed when a user does not select a specific template file.

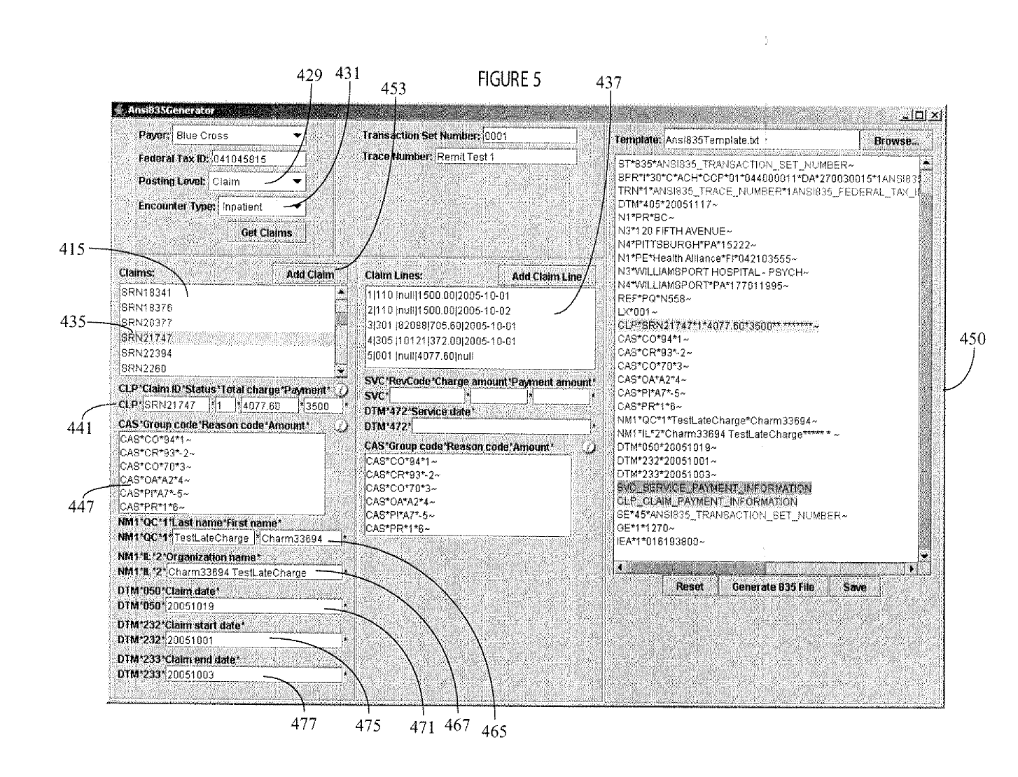

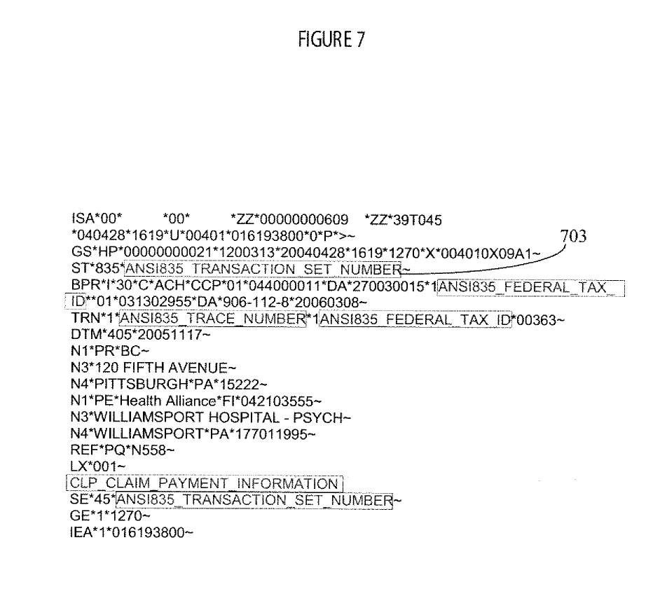

FIG. 5 shows user interface display image 450 similar to image display 303 (FIG. 3) employed by the system for providing electronic transaction data illustrating selection of financial claims to be included in a test file. Candidate claims (and associated claim data) acquired by system 10, available for selection to be conveyed by a template transaction message test data file, are filtered in response to user selectable filter criteria. System 10 acquires available claims that satisfy filter criteria set by the user in display image 450 (FIG. 5) and provides data comprising the claims to workstation 12 (FIG. 1) in step 106. The claim data is retrieved from repository (database) 17 by using SQL and business logic existing in a healthcare information system being tested, so retrieved data maintains logic relationships that are required in an 835 file. An EDI 835 template test data file that conforms to EDI 835 file format is created and verified. The template file contains tags (place holders) that are filled in using data retrieved from repository 17. At time of generating an EDI 835 test data file, system 10 matches data retrieved from repository 17 with the tags in the template and inserts claim data of user selected claims into appropriate locations in the template file. FIG. 7 shows an EDI 835 test data template file indicating tags comprising place holder elements identified within rectangles e.g., ANSI835_TRANSACTION_SET_NUMBER 703, that are filled in using data retrieved from repository 17.

The user can further limit the claim data acquired by selecting claims that were posted at claim level or claim line level via option box 429 (FIG. 5) and by only including inpatient or outpatient encounter claim data via option box 431. The filter options selectable via display image 450 enable system 10 to construct test data files for various test scenarios. Claim list box 415 indicates claims acquired in response to user selectable filter criteria options selected in boxes 429 and 431.

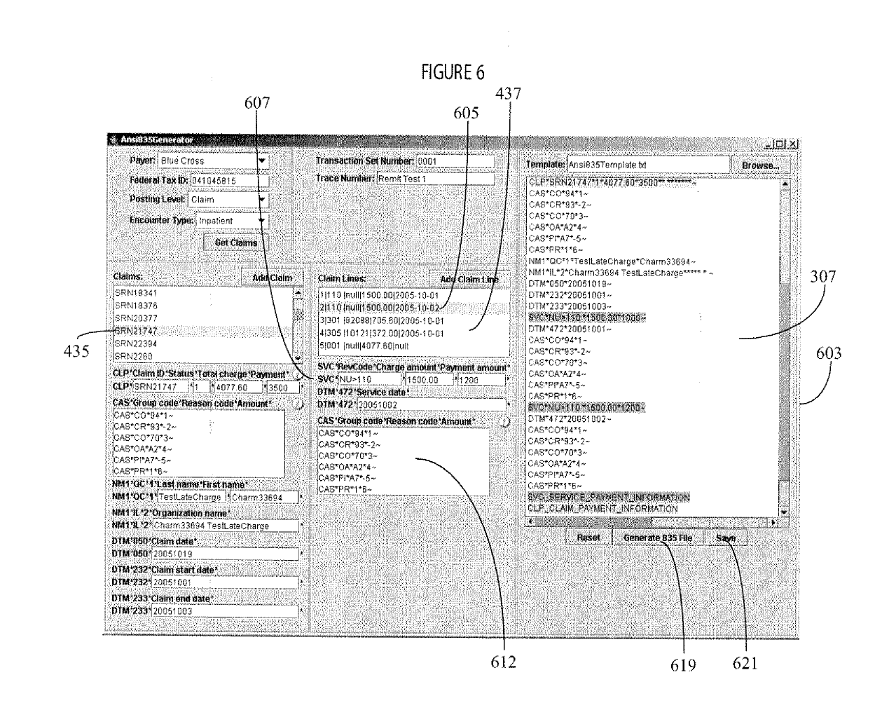

In response to user selection (e.g., via mouse click of a row in claim list box 415) of a claim indicated in claim list box 415 (e.g., claim 435) system 10 acquires detailed information of selected claim 435 and populates claim line list box 437 with claim lines for selected claim 435. A user selects claims for which EDI 835 test data files are to be created and enters payments and adjustments data in step 108 (FIG. 1). Specifically, a user enters payment status and payment amount in boxes on row 441 (claim identifier and total charge are automatically pre-populated). If an entered payment is less than the total charge amount, one or more adjustments may be entered in claim adjustment list box 447. Claim Adjustment segment (CAS) codes are used in claim rejection (adjudication) data to adjust payment amount. Other information including patient name 465, organization name 467, claim date 471, claim start date 475 and claim end date 477 for a selected claim (e.g., 435) are automatically populated in display image 450. The selected claim 435 and entered data (payment, adjustments) can be added to a test file in text box 307 (FIG. 6) by clicking on “Add Claim” button. This step is repeated as necessary to add more claims to a test file.

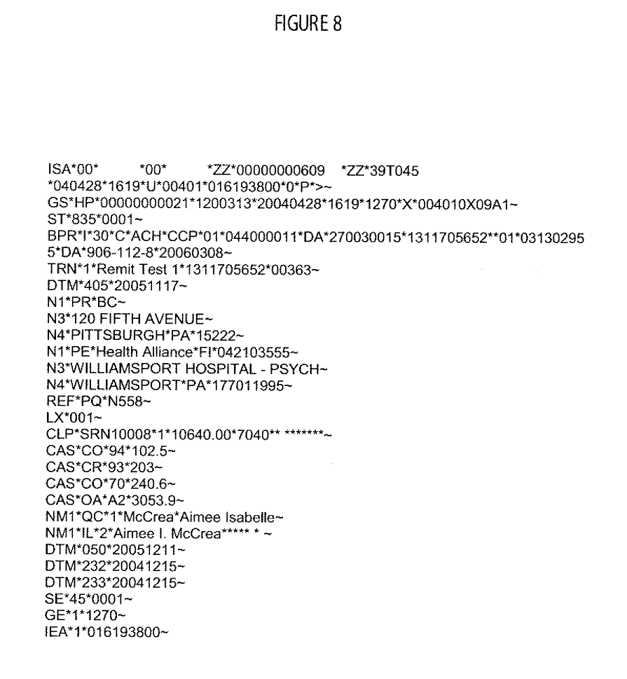

FIG. 6 shows user interface display image 603 employed by system 10 for providing electronic transaction data illustrating selection of lines of financial claims to be included in a test file. The claim lines for the claim 435 selected in step 108 (FIG. 1) are populated in claim lines list box 437 (FIG. 5). In response to user selection of claim line 605 (e.g., via mouse click) in box 437 detailed information for claim line 605 such as revenue code, procedure code and procedure modifiers are retrieved from repository 17. A user enters a payment amount for individual claim line 605 in boxes on row 607 (revenue code and total charge amount are automatically pre-populated). If an entered payment amount is less than the total charge amount, the user can also enter adjustments for a selected claim line in box 612. The selected claim line 605 and entered data (payment, adjustments) can be added to a test file in text box 307 by clicking on “Add Claim Line” button. This step can be repeated to add more claim lines to the test file. System 10 retrieves detailed information for claims that the user selected to be included in the EDI 835 test data file and generates an output file in step 110. Specifically, a user adds claims and claim lines to the EDI 835 test data file and selects button 619 to initiate generation of a test data file as an output file involving replacement of tag identified placeholders in a test template with individual selected claim and claim line data elements. The generated file is displayed in text box 307. FIG. 8 illustrates a generated EDI 835 test data file. The user can further edit the generated file to provide a specific test case and in response to selection of button 621, the user is prompted to select a location either on a local or network drive to save the output file in step 112 (FIG. 1) and system 10 saves the output file at the user selected location in step 114. System 10 may be used for coding and testing new features or debugging existing code in electronic remittance processing. System 10 validates EDI 835 file processing is working properly after updates to a healthcare information system and enables pre-validation of 835 file processing while negotiating electronic remittance agreements with payers. System 10 further supports self test to ensure EDI 835 forms are correctly generated.

System 10 automatically extracts data from existing payer organizations and claims eliminating a need to manually search data in a healthcare financial information system database for valid claim data to be used in an EDI 835 test remittance file. System 10 ensures claim data used in generating an EDI 835 test data file belongs to the same payer organization that the EDI 835 file is targeted to and uses existing programmed business logic to generate an EDI 835 test data file. Thereby the system ensures synchronization with existing business rules, reduces data integrity problems, ensures correct formatting of an EDI 835 file and enables generation of large amounts of test data quickly. The generated test data provides higher quality and improved test coverage of remittance processing and supports test driven software development at reduced cost since an analyst is no longer required to edit test data to generate valid test cases and uses pre-defined test file templates to provide expert knowledge for a user application. In contrast known systems employ a time consuming manual error prone process that requires extensive system knowledge in providing EDI 835 test data typically involving multiple iterations.

The system, involving automatically extracting existing data generated by a tested software module to test a newly developed or modified software module, is applicable for use in test driven development (TDD). Test data and test fixture developed in TDD are static and tied to existing data in database. When a database is changed or when software is moved to another database, the existing test data or test fixture becomes obsolete. The system extracts test data from the targeted database at the time of testing to ensure the test data and format is compatible with data existing in the database. A test file is generated by selecting a template file which enforces the format of the file and by replacing special tags in the template file with data retrieved from a database. The system is extensible to generate other types of test files. The system facilitates building template files for ADT (Admission, Discharge and Transfer), Charge, Guarantor Payment/Adjustment, Insurance Adjustments, etc, with special tags and replacing these tags with data retrieved from a database. At run time, the program determines what type of test files need to be generated by looking at the template file and extracts appropriate data from a database to plug into template file.

FIG. 9 shows system 10 for performing a process for providing electronic transaction data for use in testing an executable application. System 10 includes client devices (workstations) 12 and 14, repository 17 and server 20 intercommunicating via network 21. Repository 17 comprises a source of a predetermined template transaction file and including at least one placeholder tag representing a transaction data element for replacement by a corresponding transaction data element derived from stored non-test transaction data. Acquisition processor 39 acquires payer specific non-test transaction data of a predetermined type from a transaction data repository (in repository 17). The transaction data is EDI 835 compatible claim payment advice transaction data. Specifically, the non-test transaction data is healthcare claim data previously submitted to a payer organization for reimbursement of patient healthcare claims.

Data generator 25 matches and replaces a placeholder tag in predetermined template transaction file data with a corresponding transaction data element in the acquired payer specific non-test transaction data of the predetermined type to provide output transaction data. Data Generator 25 incorporates a corresponding transaction data element in the acquired transaction data of the predetermined type in a location identified by the matching, to provide output transaction data specific to a particular payer organization for reimbursing healthcare claims. User interface 26 initiates generation of data representing at least one display image enabling a user to, select a predetermined template transaction file from multiple stored predetermined template transaction files and select the predetermined type of the non-test transaction data.

The at least one display image enables a user to select an individual claim (having been previously submitted to a particular payer) as a source of the corresponding transaction data element and comprising a non-test transaction including a corresponding transaction data element. The at least one display image also enables a user to select the individual claim from multiple different claims presented in an image area and previously submitted to the particular payer. The multiple different claims being identified by automatically searching a repository of claim data for claims associated with the particular payer. The non-test transaction data includes a total claim charge amount and the at least one display image enables a user to enter a total payment amount and to enter an associated payment code. The non-test transaction data also includes a total claim line charge amount. Also the at least one display image enables a user to select an individual claim line as a source of a corresponding transaction data element and enables a user to enter a total payment amount for a claim line less than the total claim line charge amount and to enter an associated adjustment. In one embodiment the at least one display image comprises a single display image. Filter processor 15 automatically searches for the non-test transaction data of a predetermined type in the transaction data repository in response to user entered search criteria. The at least one display image enables a user to filter claims using filter processor 15 derived by automatically searching repository 17 claim data based on whether claims are for inpatient or outpatient treatment or in response to user selection of at least one Of, (a) claim start date and (b) claim end date.

The systems and processes of FIGS. 1-9 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. System 10 is usable in any field to provide electronic transaction message test data using real transaction message data for testing or validating a financial information system The processes and applications may in alternative embodiments, be located on one or more (e.g., distributed) processing devices accessing a network linking the elements of FIG. 9. Further, any of the functions and steps provided in FIGS. 1-9 may be implemented in hardware, software or a combination of both and may reside on one or more processing devices located at any location of a network linking the elements of FIG. 9 or another linked network including the Internet.

What is claimed is:

1. A system for providing electronic transaction data for use in testing an executable application, comprising:
a source of a predetermined template transaction file comprising data representing a transaction and including at least one placeholder tag representing a transaction data element for replacement by a corresponding transaction data element derived from stored non-test transaction data;
an acquisition processor for acquiring non-test transaction data of a predetermined type from a transaction data repository; and
a data generator for matching and replacing a placeholder tag in predetermined template transaction file data with a corresponding transaction data element in said acquired transaction data of said predetermined type to provide output transaction data.

2. A system according to claim 1, wherein
said transaction data is EDI 835 compatible claim payment advice transaction data.

3. A system according to claim 1, wherein
said non-test transaction data is healthcare claim data previously submitted to a payer organization for reimbursement of patient healthcare claims.

4. A system according to claim 1, wherein
said output transaction data is specific to a particular payer organization for reimbursing healthcare claims,
said acquisition processor acquires payer specific non-test transaction data of a predetermined type from a transaction data repository; and
said data generator matches and replaces a placeholder tag in payer specific predetermined template transaction file data with a corresponding transaction data element in said acquired payer specific non-test transaction data of said predetermined type to provide output transaction data.

5. A system according to claim 1, including
a user interface for initiating generation of data representing at least one display image enabling a user to select an individual claim as a source of said corresponding transaction data element, said individual claim having been previously submitted to a particular payer.

6. A system according to claim 5, wherein
said non-test transaction data includes a total claim charge amount and
said at least one display image enables a user to enter a total payment amount and an associated payment code.

7. A system according to claim 5, wherein
said non-test transaction data includes a total claim line charge amount and
said at least one display image enables a user to enter a total payment amount for a claim line and an associated payment code.

8. A system according to claim 5, wherein
said at least one display image enables a user to select an individual claim as a source of said corresponding transaction data element.

9. A system according to claim 5, wherein
said at least one display image enables a user to select an individual claim line as a source of said corresponding transaction data element.

10. A system according to claim 8, wherein
said at least one display image comprises a single display image.

11. A system according to claim 5, wherein
said at least one display image enables a user to select said individual claim from a plurality of different claims presented in an image area and previously submitted to said particular payer, said plurality of different claims being identified by automatically searching a repository of claim data for claims associated with said particular payer.

12. A system according to claim 10, wherein
said at least one display image enables a user to filter claims derived by automatically searching said repository of claim data based on whether claims are for inpatient or outpatient treatment.

13. A system according to claim 12, wherein
said at least one display image enables a user to filter claims derived by automatically searching said repository Of claim data in response to user selection of at least one of, (a) claim start date and (b) claim end date.

14. A system for providing electronic transaction data for use in testing an executable application, comprising:
a source of a predetermined template transaction file comprising data representing a transaction and including at least one placeholder tag representing a transaction data element for replacement by a corresponding transaction data element derived from stored non-test transaction data;
an acquisition processor for acquiring non-test transaction data of a predetermined type from a transaction data repository; and
a data generator for,
matching a placeholder tag in predetermined template transaction file data with a corresponding transaction data element in said acquired transaction data of said predetermined type and
incorporating a corresponding transaction data element in said acquired transaction data of said predetermined type in a location identified by said matching, to provide output transaction data specific to a particular payer organization for reimbursing healthcare claims.

15. A system according to claim 14, including
a user interface for providing data representing at least one display image enabling a user to,
select a predetermined template transaction file from a plurality of stored predetermined template transaction files and
select said predetermined type of said non-test transaction data.

16. A system according to claim 14, including
a filter processor for automatically searching for said non-test transaction data of a predetermined type in said transaction data repository in response to user entered search criteria.

17. A system for providing electronic transaction data for use in testing an executable application, comprising:
a source of a predetermined template transaction file comprising data representing a transaction and including at least one placeholder tag representing a transaction data element for replacement by a corresponding transaction data element derived from stored non-test transaction data;
a user interface for initiating generation of data representing at least one display image enabling a user to select an individual claim comprising said non-test transaction including said corresponding transaction data element, said individual claim having been previously submitted to a particular payer;
an acquisition processor for acquiring non-test transaction data of a predetermined type from a transaction data repository; and
a data generator for matching and replacing a placeholder tag in predetermined template transaction file data with a corresponding transaction data element in said acquired transaction data of said predetermined type to provide output transaction data specific to a particular payer organization for reimbursing healthcare claims.
